(19) United States
(12) Patent Application Publication
(10) Pub. No.: US 2007/0276918 A1
(43) Pub. Date: Nov. 29, 2007

(54) Symbol Mapping For Browser-Based Data Retrieval

(76) Inventor: Ian Alderson, Kingston Upon Thames (GB)

Correspondence Address: LOWRIE, LANDO & ANASTASI, RIVERFRONT OFFICE, ONE MAIN STREET, ELEVENTH FLOOR, CAMBRIDGE, MA, 02142, US

(21) Appl. No.: 10/581,871

(22) PCT Filed: Dec. 3, 2004
(86) PCT No.: PCT/GB04/05114

§ 371 Date: Jul. 16, 2007

(30) Foreign Application Priority Data
Dec. 5, 2003 (GB) 0328251.4

(51) Int. Cl. G06F 17/30

(52) U.S. Cl. 709/217

(57) ABSTRACT

Real-time financial data from a number of independent data sources is displayed in separate frames within a single browser window. Each frame displays data from a different source, each source having its own symbology for representing the data. The web page which provides the browser display includes mapping algorithms for mapping between the symbology used by different sites. A user can change one symbol within one frame and the change is automatically propagated to all of the frames pre-selected by the user.

### FIELD OF INVENTION

This invention relates to a method of retrieving data from a plurality of independent data sources for concurrent display by a browser.

### BACKGROUND

Traditionally, the provision of financial market data to financial trading professionals was done through dedicated information terminals, supplied by the providers of the information services being offered. The need for these professionals to have simultaneous access to up-to-date information from a variety of sources resulted in each of them having numerous terminals and screens from different providers. This traditional environment revolved around orderly and clearly defined symbologies for referring to particular financial instruments and particular items of data.

In recent years, information vendors have increased their use of the Internet as an information delivery platform and there are now a multiplicity of service providers providing a wealth of financial information over the Web. To address the need for concurrent access to information from different service providers, products such as Caplin Systems Limited's Websheet™ browser software, running on a client computer, provide a split screen display within a single browser window, permitting information from different servers to be displayed within their own frames in different areas of the screen, as shown in FIG. 1. In this example, the browser window is divided into seven frames, each displaying different types of information from a variety of independent service providers.

However, in contrast to the world of conventional financial market data, providers of the financial information available on the Web tend to use ad-hoc and arbitrary ways of referring to their data. Each service provider has its own access requirements and uses its own symbology to represent the particular financial instruments and items of data on which it provides information.

For example, financial market data is usually related to individual companies that have been floated on a particular stock market. For ease of reference, most service providers assign each such company a quick-reference symbol. However, although the symbol generally includes some abbreviation of the company's name and possibly also the market on which the company is traded, different service providers in the market data field have adopted differing symbol formats. For example, the Vodafone Group™ is referred to by a variety of different symbols, including the symbol VOD.L, VOD.LSE, LSE/VOD and LO/VOD by different service providers, the ‘VOD’ referring to the company and the ‘L’, ‘LSE’ and ‘LO’ referring to the London Stock Exchange.

Therefore, where a user wishes to request particular information about a chosen company from a particular service provider, he or she must provide the correct symbol to the provider's website. In the example of the Websheet™ product shown in FIG. 1, this would mean entering the provider's symbol into the appropriate frame that relates to that provider.

However, where a user wishes to look at a particular company in more detail, it is a relatively common requirement that the user would wish to see all of the available information about the company from a number of different information providers. For example, the user may wish to see the company's latest share price as well as any news relating to that company. In the Websheet™ example shown in FIG. 1, the user may therefore wish to see details of the company's latest share price in a first frame 1 provided by a first provider, a chart of the company's historical performance in a second frame 2 provided by a second provider and news related to the company in a third frame 3 provided by yet another service provider. Achieving this with current technologies requires the user to enter the different symbols used by each of the service providers into each of the required frames. While sophisticated users may know the symbols used by the different service providers, it is still time consuming and laborious to enter this information into each frame separately.

The present invention aims to address the above problem.

According to the invention there is provided a method of providing data from a plurality of remote data servers for concurrent display by a browser, the method comprising the steps of receiving a symbol representing a data selection, mapping the symbol to respective symbols used by each of the data servers to represent the data selection, sending the mapped symbols to their respective data servers, receiving data corresponding to the mapped symbols from each of the data servers and displaying the received data concurrently within a browser window.

The ability to perform automatic mapping of symbols at the client computer before sending the mapped symbols to the various data servers, avoids the need for the user to learn and type in numerous different symbols for each of the information services being accessed. This saves considerable time and effort on the user's part, in what is typically a time critical environment.

The browser window is preferably divided into a plurality of frames, each frame displaying data from one of the data servers, and the method may further comprise automatically changing the data in one or more of the frames in response to a symbol entered by a user in one of the other of the plurality of frames.

The method may further comprise linking the frames in which data is to be automatically changed, the linked frames defining selected ones of the data servers to which mapped symbols are to be sent. The linked frames may be defined by the user, for example by right clicking in each of the frames and ticking a link option.

A user need only change a single symbol within the browser window and the change is automatically propagated through to all of the other frames within the window, or to all those frames selected by the user. This permits the user to easily configure his or her browser display.

The method may further comprise the step of retrieving mapping information, for example, mapping data or a mapping algorithm stored on the client computer or embedded in the web page script that provides the browser display, for use in mapping the received symbol to symbols to be sent to each of the selected data servers.

By allowing the user to access and easily manipulate the mapping information or algorithms, users are enabled to create their own mapping algorithms for sites which are initially unsupported by the web page script. They are also enabled to easily build display profiles, each comprising their own unique matrix of data to service mappings.

The method may further comprise the step of retrieving a resource identifier, for example a url, which identifies each of the selected data servers.

Preferably, the method further comprises, for each of the selected data servers, the step of synthesising a link to the corresponding data, the link comprising a synthesis of the resource identifier and the mapped symbol for the selected data server. The synthesised link may then be used to connect to the respective data server and request the corresponding data in accordance with the mapped symbols

According to the invention, there is still further provided a method of retrieving data from a remote data server for display at a browser, the method comprising receiving a first symbol representing a first data selection, transforming said first symbol to a second symbol, synthesising said second symbol with a resource identifier identifying the location of the data server to provide a link to the data server, initiating a connection to the data server via the synthesised link, receiving a response from the data server and determining whether the response provides a second data selection corresponding to the first data selection.

The method may comprise transforming the first symbol to the second symbol by selecting the second symbol from one of a plurality of predefined symbols or by transforming the first symbol to the second symbol in a predetermined manner.

If the selected data server returns a proper response in accordance with the second symbol, namely a response in which the data corresponding to the first symbol is retrieved, the server may be added to a list of available information service providers.

If the selected data server does not return a proper response, the user may be informed, to enable him to carry out manual program amendments to conform with the particular requirements of the selected site. Alternatively, or in addition, the program may automatically use a different transformation to transform the first symbol to the second symbol and repeat the steps of synthesising a link to the data server, connecting to the data server, receiving a response from the data server and determining whether the response provides a selection which corresponds to the first data selection.

By providing automated tools to assist the user in adding additional information providers, the invention can make it simpler for the user to create customised display profiles without needing to understand the complexity of the underlying mapping algorithms.

As part of the automation process, the default symbol may be repeatedly transformed into various different possible symbols, in an attempt to crack the particular symbol code which the selected site uses to provide data corresponding to the default symbol.

According to the invention, there is yet further provided A program for providing data from a plurality of remote data servers for concurrent display by a browser, the program comprising means for receiving a symbol representing a data selection, means for mapping said symbol to respective symbols used by each of the data servers to represent said data selection, means for sending the mapped symbols to their respective data servers, means for receiving data corresponding to the mapped symbols from each of the data servers and means for displaying the received data concurrently within a browser window.

According to a farther aspect of the invention, there is provided a program for retrieving data from a remote data server for display at a browser, the program comprising means for receiving a first symbol representing a first data selection, means for transforming said first symbol to a second symbol, means for synthesising said second symbol with a resource identifier identifying the location of the data server to provide a link to the data server, means for initiating a connection to the data server via the synthesised link, means for receiving a response from the data server and means for determining whether the response provides a second data selection corresponding to the first data selection.

### BRIEF DESCRIPTION OF THE DRAWINGS

Embodiments of the invention will now be described, by way of example, with reference to the accompanying drawings, in which:

FIG. 1 depicts a browser screen using Caplin Systems Limited's Websheet™ software to display market data from a variety of different service providers within different frames on a single browser screen;

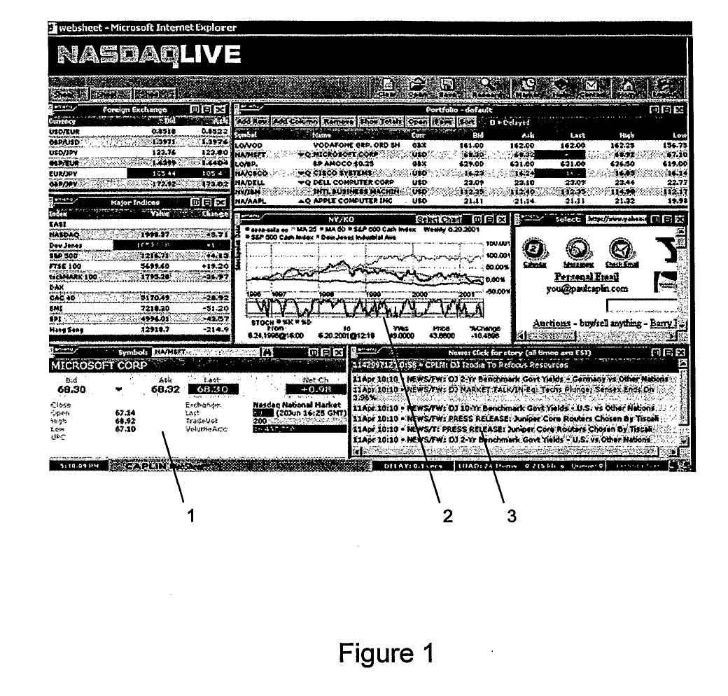

FIG. 2 depicts a browser screen for entry of details of information requirements according to one embodiment of the invention;

FIG. 3 is a flowchart illustrating the steps carried out by a web page program in accordance with the invention to implement automatic frame linking;

FIG. 4 is a flowchart illustrating the steps carried out by a mapping algorithm as part of the web page program illustrated in FIG. 3;

FIG. 5 depicts a browser screen according to one embodiment of the invention displaying frame linked information in multiple frames, with a control frame for entry of a default symbol;

FIG. 6 shows a browser screen in accordance with the invention, in which there is no central control frame for entry of a desired symbol, but symbols and/or names can be entered in each separate frame, from where they will propagate to other linked frames;

FIG. 7 is a flow diagram illustrating a further aspect of the invention which permits a user to add further information service providers to the list of available providers;

FIG. 8 is a flow diagram illustrating the operation of an adaptive mapping algorithm according to the invention.

### DETAILED DESCRIPTION

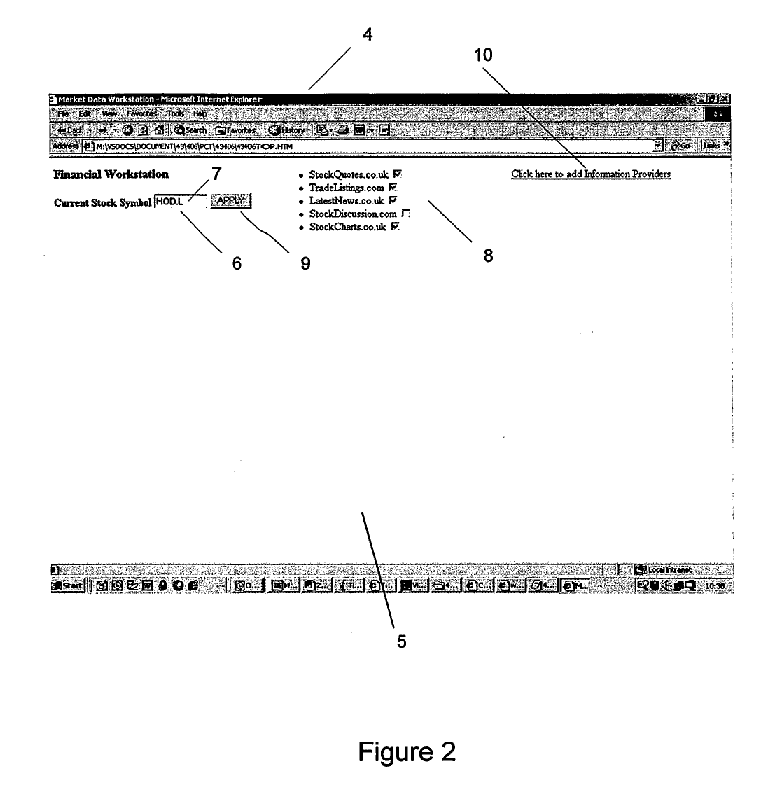

FIG. 2 illustrates an introductory web page for entry, by a user, of details of the information required for display by the browser according to one embodiment of the invention. In this example, the browser is a conventional Internet browser such as Microsoft Internet Explorer 5™, running on a client computer, and the web page is written using conventional web page technologies, including HTML and JavaScript™. The functionality provided to the user when the web page is running on the user's browser is referred to herein for convenience as the web page program, or simply the program.

In the case of financial market data, information to be displayed is grouped according to the stock to which it relates. The displayed web page 4 therefore provides users with a data entry frame 5 including a text entry box 6 to enter a symbol 7 for the particular stock in which they are interested. This is the default symbol for the program, i.e. a symbol in a predefined format which may be, for example, ‘stock code’-‘stock exchange code’. For example, a hypothetical company Holdings plc trading on the London Stock Exchange might be represented as ‘HOD.L’). As an alternative, all of the available companies are shown in a drop-down list and selected by the user from that list. This hides the symbology from the user.

A choice 8 of service providers is also provided in the example illustrated in FIG. 2. These providers all provide different forms of financial information, for example, stock prices, trading details, news, discussion forums, and charts. They may be service providers whose content is freely available to the public, or providers that enable access only to account holders. An ‘Apply’ button 9 submits the entered symbol and selected service providers to the web page program for processing. The user is able to add additional information providers to this list by clicking on a link 10 and then entering further information as prompted, as will be described in more detail later in this specification.

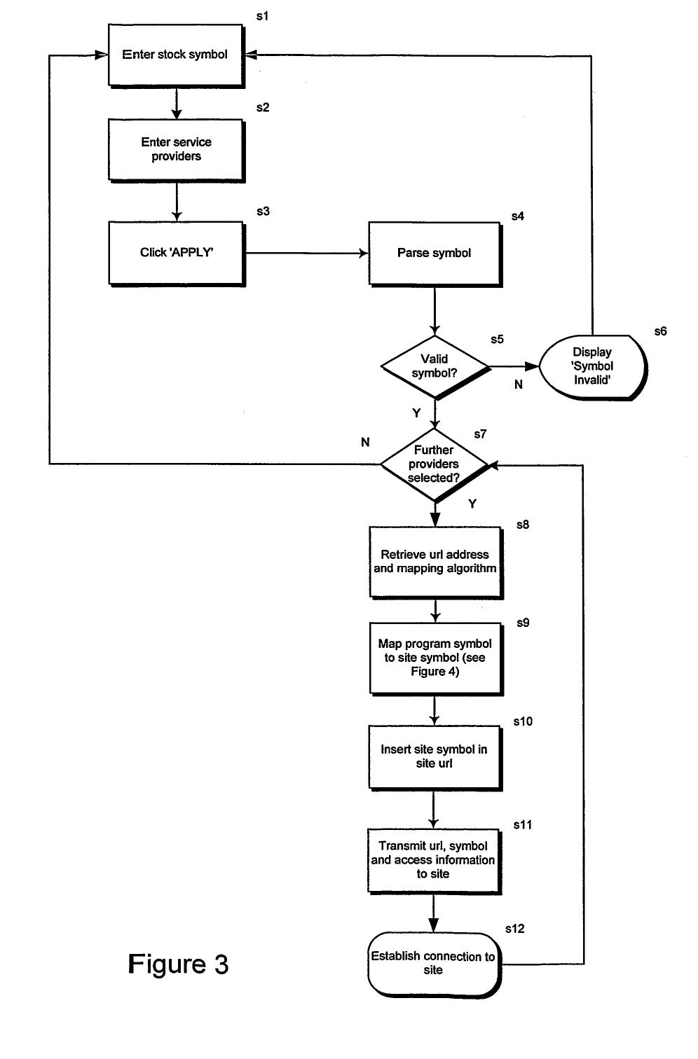

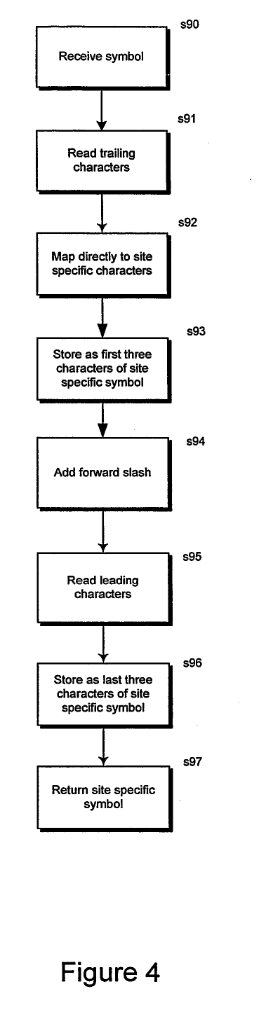

The steps carried out to display the required information will now be described in more detail with reference to FIGS. 3 and 4.

The user begins by entering the predefined stock symbol 7 for the company of interest in the text entry box 6 (step s1). In this case the chosen stock is a hypothetical company Holdings plc, which has the associated symbol, in accordance with the workstation symbology, of ‘HOD.L’. Once the stock of interest has been entered, the user next decides which information sources to view. The user selects the required sources (step s2) by ticking the appropriate selection boxes 8. In this example, all of the service providers are chosen with the exception of ‘StockDiscussion.com’, as illustrated by the ticks in their associated boxes. The user then clicks on the ‘Apply’ button 9 (step s3).

The program parses the entered symbol (step s4) and checks to ensure that the symbol corresponds to a recognised quoted company (step s5), for example against a list held locally or at a remote server. If not, it displays an invalid symbol message and requests reentry of the data (step s6). The program is then ready to proceed to the next stage, in which details relating to the company corresponding to the entered symbol are to be retrieved from each of the service providers selected by the user.

To retrieve this information from a service provider, the program requires an address for the service provider, together with the symbol that needs to be sent to the service provider to identify the selected company. However, the symbol used by the selected service provider is likely to be different to the default symbol used by the program.

Each of the service providers supported by the web page program is therefore associated with a uniform resource locator (url) address and a mapping algorithm, for mapping from the symbol format used by the program to the symbol format used by the service provider. The url and the mapping algorithm can be coded within the program, stored in a file on the user's computer, or stored on a remote server and downloaded to the user's computer when required. The user has access to this mapping information to permit it to decide for itself the services and syntax that it needs to adopt and manage to create its own display profiles. As an additional advantage, storage on a remote server can permit relatively easy updating of the url and mapping algorithm information, for example, where such information needs to be available across multiple client sites.

The next stage in program operation is for the program to retrieve, for the first selected provider (step s7), its url address and its mapping algorithm (step s8). The program then uses the mapping algorithm to map the default program symbol to the selected site symbol (step s9), in a way that will be described in more detail below with reference to FIG. 4.

The mapping algorithm comprises any means by which the default stock symbol used by the web page program can be converted to the stock symbol used by the selected service provider. The algorithm can, for example, comprise a computational process for converting between symbols, or can comprise a memory holding every symbol in the program and on the selected site, together with information defining the corresponding relationships between the symbols. Typically, the algorithm may be some combination of these two alternatives. The algorithm can be embedded within the scripting code in the web page program, so that retrieving the mapping algorithm can simply mean running the relevant portion of the code.

Considering an example mapping algorithm in more detail, the web page program uses, as the default symbol, a three letter company code, followed by a full stop, followed by a single or two letter code designating the stock exchange. In contrast, the hypothetical site StockQuotes.co.uk uses a symbol format which comprises a three letter stock exchange code, followed by a forward slash, followed by a three letter company code, which is the same code as is used by the program. Example symbols for the program and the selected site are set out below, for different companies and exchanges:

| Company | Stock Exchange | Program symbol | Site symbol |
|---|---|---|---|
| Holdings plc | London | HOD.L | LSE/HOD |
| Voxfone Group | London | VOX.L | LSE/VOX |
| Digital Comms Inc. | Nasdaq | DCO.NA | NAS/DCO |
| Nat Telecom Inc. | NYSE | NTL.NY | NYS/NTL |

Referring to FIG. 4, the program receives the checked symbol (step s90) and reads the characters following the full stop (step s91), representing the stock exchange on which the company is traded, and converts these to the symbology used by the site using the direct mapping set out below (step s92):

| Program | Site |
|---|---|
| L | LSE |
| NA | NAS |
| NY | NYS |
| [Other exchange] | [Corresponding symbol] |

For example, the character L in the program is converted to the symbol LSE for use at the selected site.

The converted symbol is stored as the first three characters of the site specific symbol (step s93). The program then inserts a forward slash as the fourth character (step s94) and then reads the characters preceding the full stop, representing the company name (step s95) and inserts them without alteration as the last three characters of the site specific symbol (step s96). The conversion is then complete and the converted symbol is returned (step s97) for insertion into the site url address (step s10 in FIG. 3). For example, on the assumption that the site uses the url format “http://www.StockQuotes.co.uk/financials/users/[symbol]” then the stored url is: “http://www.StockQuotes.co.uk/financials/users/” and the converted symbol LSE/HOL is appended to the end of this string (step s10).

T complete url is then submitted to the site, together with any necessary account and login information (step s11). A connection is then established between the browser and the selected site (step s12) and information corresponding to that symbol is retrieved for display within a browser frame, as explained in more detail below.

This principle is further illustrated in various financial websites currently in operation. For example, share price information for the Vodafone™ Group on the London Stock Exchange can be obtained from the Yahoo™ Finance site by typing in the url: “http://finance.yahoo.com/q?s=VOD.L” where the base part of the url is “http://finance.yahoo.com/q?s=” and the stock symbol is “VOD.L” which is appended to the base part to make up the complete url. Appending a different stock symbol, for example “BAY.L” brings up share price information for British Airways plc.

The same information can be obtained from the Moneyextra™ website by typing in the url: “http://wvw.moneyextra.com/stocks/LSE/VOD” where the basic url is “http://www.moneyextra.com/stocks/” and the stock symbol is “LSE/VOD”. Appending LSE/BAY instead brings up information for British Airways plc.

Therefore, conversion of our example default symbol HOD.L for these two sites requires two different algorithms. The first is a simple 1:1 mapping i.e. an exact copy of the symbol is sent to the Yahoo™ Finance site, while the Moneyextra™ site requires an algorithm as set out in FIG. 4.

Returning to our hypothetical example, the url retrieval and mapping procedure steps s7 to s12 are then carried out for each of the service providers selected by the user, with a mapping which corresponds to the symbology used by each provider. In a case where every symbol used by the provider is different from the symbol used by the program, a direct mapping needs to be stored for each symbol; in other cases algorithms similar to that described above can be provided, with only specific exceptions being stored as direct mappings.

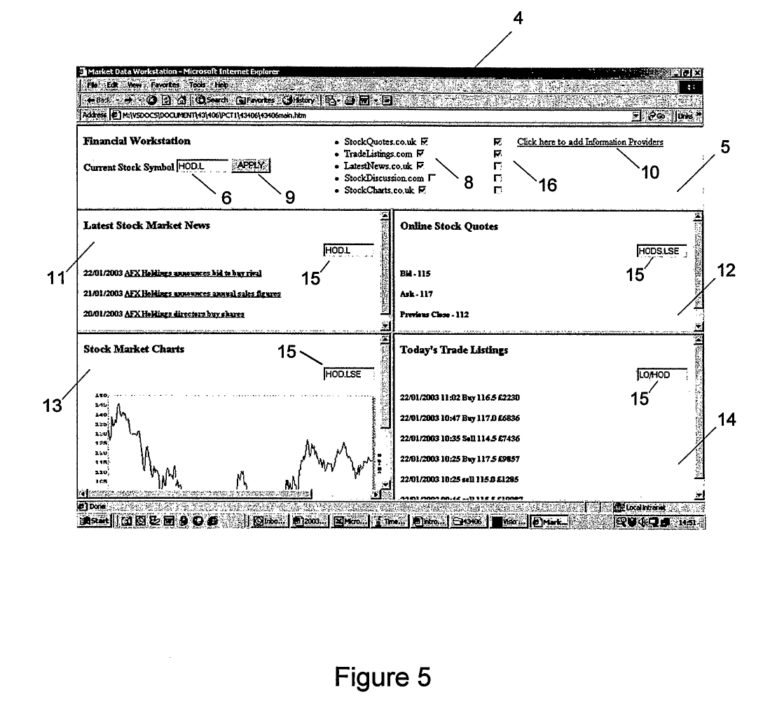

To enable the information received from the service providers to be viewed concurrently, the browser window is divided into individual frames, one for each information provider, as illustrated in FIG. 5. The browser window includes the individual frames 11-14, one for viewing the received information from each provider, as well as the data entry frame 5, so that displayed information can be updated. Frames 11-14 relate to LatestNews.co.uk, StockQuotes.co.uk, StockCharts.co.uk and TradeListings.com respectively. It can be seen that each of these, in this example, has a different symbol format 15 for representing Holdings plc on the London Stock Exchange. Each of these different symbol formats has been mapped automatically from the HOD.L symbol entered in the entry box 6.

When a user wishes to change the company information, he simply enters a new symbol into the text entry box 6 and clicks the Apply button 9, optionally changing the list of service providers 8. The process set out in FIGS. 3 and 4 is repeated to change the information displayed in all of the frames.

The way in which data is retrieved from independent sources for display in separate frames within a browser window is well known and will not therefore be described in detail further. It is, for example, used commercially within the Caplin Systems Limited Websheet™ software, which uses RTTP™ technology to provide connections to multiple sources within a single web page. Reference is also directed to our publication WO02/089003, for a detailed description of an applet-based mechanism for simultaneous display of data from independent sources within a single browser window.

It is envisaged that a user may not wish to change the information in every frame; for example, he may wish to keep existing company data for comparison with data for a new company. In this case, a mechanism is provided for the user to select only those frames for which the change should be applied. For example, a second column of tick boxes 16 is provided which the user fills in to indicate which frames should show changes in the symbol. As currently set-up in FIG. 5, if the stock symbol is changed, then these changes will only be propagated through to the StockQuotes frame and the TradeListings frame. The tick boxes 16 therefore govern the linking of the frames, but this could of course be achieved in numerous other ways, for example by providing a suitable ‘link’ option to be ticked or unticked when using a mouse to right click into each of the frames.

While the invention has been described with reference to a separate data entry frame 5 with a default program symbol, it can also be implemented by allowing the user to change the symbol used within any of the displayed frames, for example by entering a new symbol 15 within any of the frames 11-14. By analogy with the process set out in FIGS. 3 and 4, the symbols for every linked frame are recalculated, for example by using the reverse of the default symbol-to-selected site symbol algorithm, to map a selected site symbol back to the default symbol, and then using the specific default symbol-to-site symbol algorithms to map the default symbol to each of the other selected sites in accordance with the procedure shown in FIG. 3. This provides the user with additional flexibility, in that he does not need to learn an additional set of default symbols, but can use the symbols that he is familiar with from supported service providers.

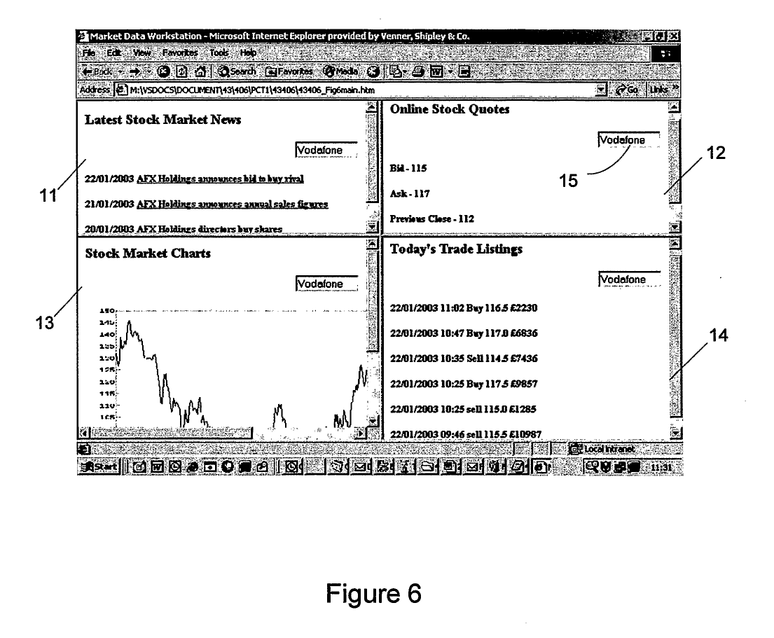

A similar situation is illustrated in FIG. 6, in which no central control frame is illustrated. In addition, each individual frame displays the name of the company, rather than just a symbol, so entirely hiding the symbology from the user. In this example, the user simply changes the name of the company in the box 15 in any of the frames 11-14 and this change is propagated to all of the other frames. The company names can be provided in a drop-down list, so that all of the available companies are shown. In this case, the company name is mapped back to the default symbol and the default symbol is mapped to the respective symbol for each of the linked frames.

On the basis that the web page program is written using Javascript™ or another scripting language, a technique which is also referred to as client-side scripting, users can create their own mappings for sites which are not intrinsically supported by the program. This mapping is then associated with a service provider by clicking on the ‘Click here to add Information Providers’ option 10 shown in FIG. 5 and providing the site url and a link to the mapping information.

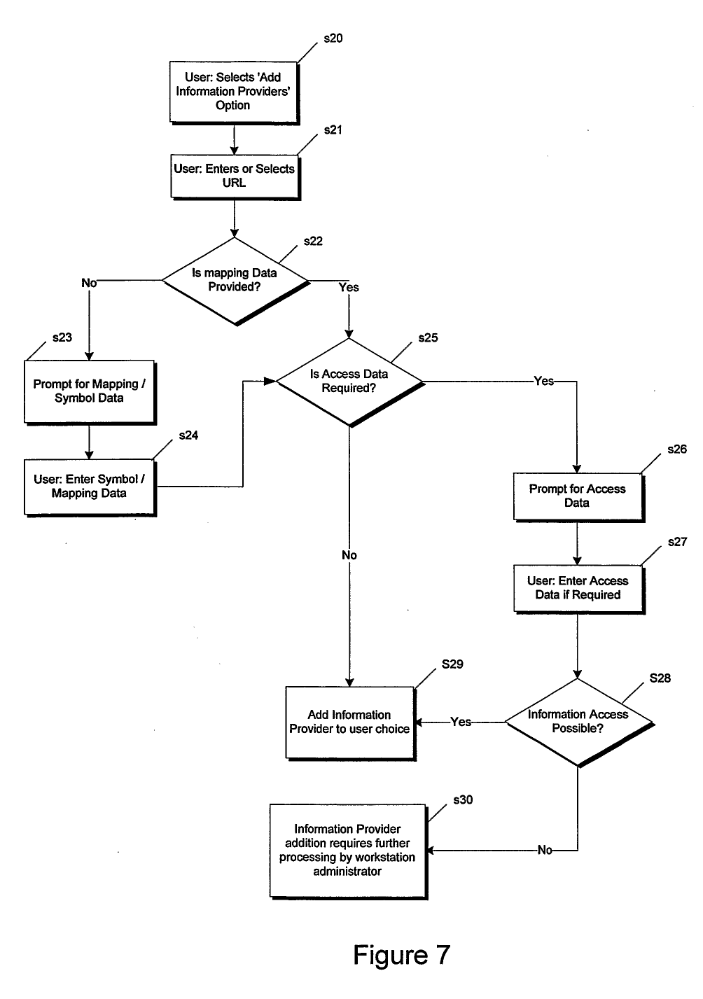

For example, referring to FIG. 7, a user selects the ‘Add Information Providers’ option 10 (step s20). He then enters a base url for the desired site or selects it from a displayed list (step s21). The program determines whether corresponding mapping data already exists (step s22). If it does not, the program prompts the user to enter the mapping data (step s23). The user enters the mapping data, by specifying the transformations required to move from the default symbology to the symbology used by the specified website (step s24). The program then determines whether access data is required (step s25). If it is, it prompts the user to enter access data (step s26) and the user enters the required data in response, for example by filling out a personal details form required by the website and choosing a username and password (step s27). The program then tests whether information access is possible by attempting a test run to retrieve information for a test company (step s28). If information access is possible, the new information provider is added to the list of available providers (step s29). If information access is not possible, the program indicates to the user that further processing is required by the user (step s30). The user may then need to make manual changes to the program to configure the url, mapping algorithm or access requirements to meet that website's particular requirements. Once these have been made, the above process is repeated to ensure that information access is possible, in which case the new information provider is added to the list of available providers (step s29).

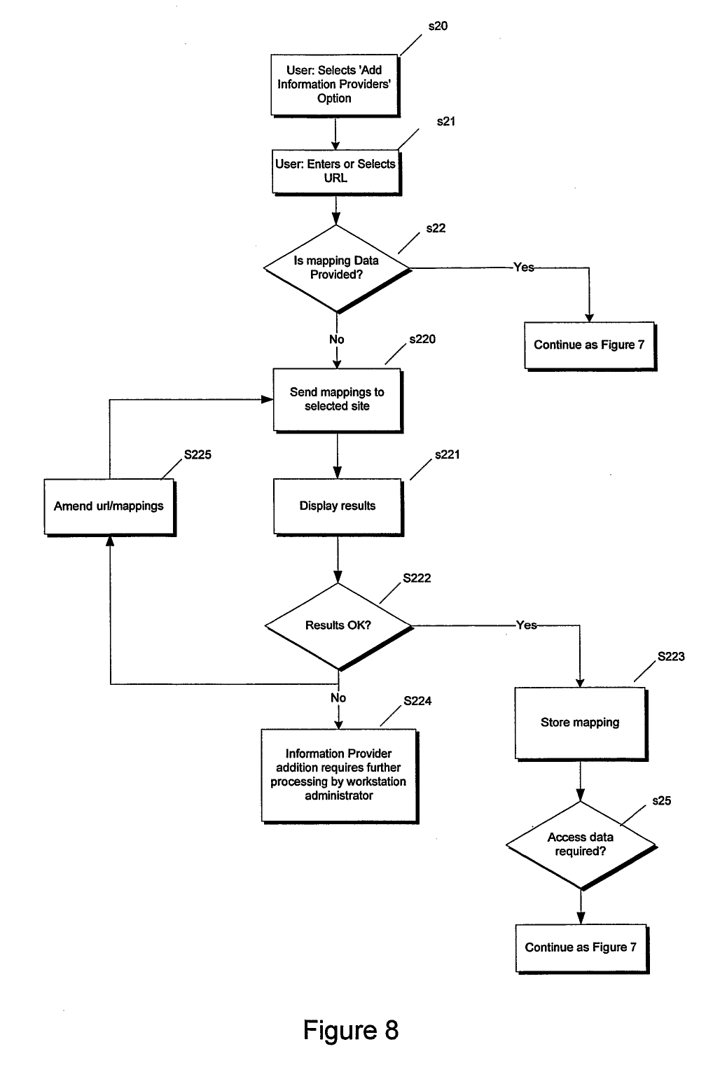

In a further example of the invention, the program is configured to provide adaptive mapping for sites that are not intrinsically supported. For example, referring to FIGS. 7 and 8, when a user clicks on the ‘Click here to add Service Providers’ option 10 (step s20), he is prompted for a url (s21). As described in relation to FIG. 7, the program then determines whether mapping information is provided (step s22). If it is, the program continues as shown in FIG. 7. If not, the program then sends one of a number of common mappings to the site for a selected symbol (s220) and displays the results of the attempted mappings to the user (step s221). For example, for Holdings plc, the program uses four different mapping algorithms to send four different symbols, for example, HOD.L, HOD.LSE, HOD/LSE and LSE/HOD to the site, and displays the results to the user, for example in four separate frames. The user can indicate to the program via a Yes, No button within each frame whether any of these frames are displaying the correct information (step s222). If so, the program stores the correct mapping against the site url (step s223). The program then deals with access data requirements, as shown in FIG. 7 at steps s25 to s30.

In the event that the mappings do not produce a useful result, the program displays a message indicating that the user needs to perform manual configuration (step s224), as described above in relation to FIG. 7. While the sending of four mappings is used as an example, there is no limit to the number of different mappings that can be sent to a site. In a further example of the invention, the program is configured to make alterations to the mappings and to keep sending mappings to the site in an attempt to find a correct mapping (step s225). The program may also be configured to make amendments to the base url in an attempt to obtain valid data. The program can further be configured to automatically detect invalid responses, for example ‘Access Denied’ or ‘Cannot Find Server’ messages on the returned page, to automatically send a different mapping to the site without user input.

The principle of frame linking described above, in which a change in information in one frame is automatically fed through to all the other linked or selected frames, can be extended to cover not only company symbols, but any data within the frame. For example, share price charts can be displayed over varying periods of time. By providing corresponding mappings that describe how different sites code such time periods, the invention is capable of automatically propagating this, or indeed any other information, between frames. For instance, the Yahoo™ Finance site uses a further search suffix code to indicate different time periods for charting, so “http://finance.yahoo.com/q?s=VOD.L&d=2” indicates a 5-day chart, while the suffix “&d=1b” indicates charting over a 1-day period.

Therefore, a user can, for example, display a chart for a particular period in one frame and news covering the same period in another frame, the period being automatically mapped between the two frames.

While the invention has been described with reference to particular examples of implementation, it will be apparent to a person skilled in the art that many different implementations are possible, while keeping to the principle that related data can be retrieved from multiple servers without the need for a user to manually enter the data requirements for each server separately.

1. A method of providing data from a plurality of remote data servers for concurrent display by a browser, the method comprising the steps of:
receiving a symbol representing a data selection;
mapping said symbol to respective symbols used by each of the data servers to represent said data selection;
sending the mapped symbols to their respective data servers;
receiving data corresponding to the mapped symbols from each of the data servers; and
displaying the received data concurrently within a browser window.

2. A method according to claim 1, wherein the browser window is divided into a plurality of frames, each frame displaying data from one of the data servers, the method comprising automatically changing the data in one or more of the frames in response to a symbol entered by a user in one of the other of the plurality of frames.

3. A method according to claim 2, further comprising linking the frames in which data is to be automatically changed, the linked frames defining selected ones of the data servers to which mapped symbols are to be sent.

4. A method according to claim 3, wherein the linked frames are defined by the user.

5. A method according to claim 3 or 4, further comprising the step of retrieving mapping information for use in mapping the received symbol to symbols to be sent to each of the selected data servers.

6. A method according to claim 5, wherein the mapping information comprises a mapping algorithm.

7. A method according to any one of claims 3 to 6, further comprising the step of retrieving a resource identifier which identifies each of the selected data servers.

8. A method according to claim 7, wherein the resource identifier comprises a uniform resource locator address (url).

9. A method according to claim 7 or 8, further comprising, for each of the selected data servers, synthesising a link to the corresponding data, the link comprising a synthesis of the resource identifier and the mapped symbol for the selected data server.

10. A method according to claim 9, comprising using the link to send the mapped symbols to each of the selected data servers.

11. A method of retrieving data from a remote data server for display at a browser, the method comprising:
receiving a first symbol representing a first data selection;
transforming said first symbol to a second symbol;
synthesising said second symbol with a resource identifier identifying the location of the data server to provide a link to the data server;
initiating a connection to the data server via the synthesised link;
receiving a response from the data server; and
determining whether the response provides a second data selection corresponding to the first data selection.

12. A method according to claim 11, comprising transforming the first symbol to the second symbol by selecting the second symbol from one of a plurality of predefined symbols.

13. A method according to claim 11, comprising transforming the first symbol to the second symbol in a predetermined manner.

14. A method according to any one of claims 11 to 13, further comprising adding the data server to a list of available information service providers in the event that the second data selection corresponds to the first data selection.

15. A method according to any one of claims 11 to 13, comprising, in the event that the response does not provide a second data selection which corresponds to the first data selection, informing the user.

16. A method according to any one of claims 11 to 13, comprising, in the event that the response does not provide a second data selection which corresponds to the first data selection, using a different transformation to transform the first symbol to the second symbol and repeating the steps of synthesising a link to the data server, connecting to the data server, receiving a response from the data server and determining whether the response provides a selection which corresponds to the first data selection.

17. A method according to any one of the preceding claims, wherein the data is real-time streamed data.

18. A program for enabling data from a plurality of remote data servers to be concurrently displayed by a browser, the program being operative, when downloaded to the browser, to perform the method of any one of the preceding claims.

19. A program according to claim 18, wherein the program includes mapping information for use in the step of mapping the received symbol.

20. A program according to claim 18, further comprising means for retrieving mapping information from a client computer on which the program is running for use in the step of mapping the received symbol.

21. A program according to claim 18, further comprising means for retrieving mapping information from a remote server for use in the step of mapping the received symbol.

22. A program according to any one of claims 18 to 21, wherein the mapping information comprises a mapping algorithm.

23. A program for providing data from a plurality of remote data servers for concurrent display by a browser, the program comprising:
means for receiving a symbol representing a data selection;
means for mapping said symbol to respective symbols used by each of the data servers to represent said data selection;
means for sending the mapped symbols to their respective data servers;
means for receiving data corresponding to the mapped symbols from each of the data servers; and
means for displaying the received data concurrently within a browser window.

24. A program for retrieving data from a remote data server for display at a browser, the program comprising:
means for receiving a first symbol representing a first data selection;
means for transforming said first symbol to a second symbol;
means for synthesising said second symbol with a resource identifier identifying the location of the data server to provide a link to the data server;
means for initiating a connection to the data server via the synthesised link;
means for receiving a response from the data server; and
means for determining whether the response provides a second data selection corresponding to the first data selection.
